(19) United States
(12) Patent Application Publication
(10) Pub. No.: US 2026/0304346 A1
(43) Pub. Date: Oct. 1, 2026

(54) SIDELINK POSITIONING REFERENCE SIGNAL CONFIGURATION

(71) Applicant: Nokia Technologies Oy, Espoo (FI)

(72) Inventors: Prajwal KESHAVAMURTHY, Munich (DE); Oana-Elena BARBU, Aalborg (DK); Torsten WILDSCHEK, Gloucester (GB)

(21) Appl. No.: 18/996,470

(22) PCT Filed: Jun. 20, 2023
(86) PCT No.: PCT/EP2023/066526

§ 371 Date: Jan. 17, 2025

(30) Foreign Application Priority Data
Aug. 12, 2022 (FI) 20225723

(51) Int. Cl. H04W 64/00; H04B 17/318; H04W 72/044

(52) U.S. Cl. CPC H04W 64/00; H04B 17/328; H04W 72/044

(57) ABSTRACT

Disclosed is a method comprising transmitting, to one or more user devices, a message comprising a first reference signal and a first set of masks; receiving, from the one or more user devices, at least one of the following: first masked channel information per mask of the first set of masks, or a preferred sidelink positioning reference signal configuration based on the first masked channel information; and determining a first sidelink positioning reference signal configuration based at least partly on the first masked channel information or the preferred sidelink positioning reference signal configuration.

### FIELD

The following example embodiments relate to wireless communication and to positioning.

### BACKGROUND

Positioning technologies may be used to estimate a physical location of a device. There is a challenge in how to select an appropriate positioning reference signal configuration in order to provide high positioning accuracy and low latency.

### BRIEF DESCRIPTION

The scope of protection sought for various example embodiments is set out by the claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions which, when executed by the at least one processor, cause the apparatus at least to: transmit, to one or more user devices, a message comprising a first reference signal and a first set of masks; receive, from the one or more user devices, at least one of the following: first masked channel information per mask of the first set of masks, or a preferred sidelink positioning reference signal configuration based on the first masked channel information; and determine a first sidelink positioning reference signal configuration based at least partly on the first masked channel information or the preferred sidelink positioning reference signal configuration.

According to another aspect, there is provided an apparatus comprising: means for transmitting, to one or more user devices, a message comprising a first reference signal and a first set of masks; means for receiving, from the one or more user devices, at least one of the following: first masked channel information per mask of the first set of masks, or a preferred sidelink positioning reference signal configuration based on the first masked channel information; and means for determining a first sidelink positioning reference signal configuration based at least partly on the first masked channel information or the preferred sidelink positioning reference signal configuration.

According to another aspect, there is provided a method comprising: transmitting, to one or more user devices, a message comprising a first reference signal and a first set of masks; receiving, from the one or more user devices, at least one of the following: first masked channel information per mask of the first set of masks, or a preferred sidelink positioning reference signal configuration based on the first masked channel information; and determining a first sidelink positioning reference signal configuration based at least partly on the first masked channel information or the preferred sidelink positioning reference signal configuration.

According to another aspect, there is provided a computer program comprising instructions which, when executed by an apparatus, cause the apparatus to perform at least the following: transmitting, to one or more user devices, a message comprising a first reference signal and a first set of masks; receiving, from the one or more user devices, at least one of the following: first masked channel information per mask of the first set of masks, or a preferred sidelink positioning reference signal configuration based on the first masked channel information; and determining a first sidelink positioning reference signal configuration based at least partly on the first masked channel information or the preferred sidelink positioning reference signal configuration.

According to another aspect, there is provided a computer readable medium comprising program instructions which, when executed by an apparatus, cause the apparatus to perform at least the following: transmitting, to one or more user devices, a message comprising a first reference signal and a first set of masks; receiving, from the one or more user devices, at least one of the following: first masked channel information per mask of the first set of masks, or a preferred sidelink positioning reference signal configuration based on the first masked channel information; and determining a first sidelink positioning reference signal configuration based at least partly on the first masked channel information or the preferred sidelink positioning reference signal configuration.

According to another aspect, there is provided a non-transitory computer readable medium comprising program instructions which, when executed by an apparatus, cause the apparatus to perform at least the following: transmitting, to one or more user devices, a message comprising a first reference signal and a first set of masks; receiving, from the one or more user devices, at least one of the following: first masked channel information per mask of the first set of masks, or a preferred sidelink positioning reference signal configuration based on the first masked channel information; and determining a first sidelink positioning reference signal configuration based at least partly on the first masked channel information or the preferred sidelink positioning reference signal configuration.

According to another aspect, there is provided an apparatus comprising at least one processor, and at least one memory storing instructions which, when executed by the at least one processor, cause the apparatus at least to: apply a first set of masks to a first reference signal; measure, from the first reference signal applied with the first set of masks, first masked channel information per mask of the first set of masks; and transmit, to a user device, at least one of the following: the first masked channel information, or a first sidelink positioning reference signal configuration based on the first masked channel information.

According to another aspect, there is provided an apparatus comprising: means for applying a first set of masks to a first reference signal; means for measuring, from the first reference signal applied with the first set of masks, first masked channel information per mask of the first set of masks; and means for transmitting, to a user device, at least one of the following: the first masked channel information, or a first sidelink positioning reference signal configuration based on the first masked channel information.

According to another aspect, there is provided a method comprising: applying a first set of masks to a first reference signal; measuring, from the first reference signal applied with the first set of masks, first masked channel information per mask of the first set of masks; and transmitting, to a user device, at least one of the following: the first masked channel information, or a first sidelink positioning reference signal configuration based on the first masked channel information.

According to another aspect, there is provided a computer program comprising instructions which, when executed by an apparatus, cause the apparatus to perform at least the following: applying a first set of masks to a first reference signal; measuring, from the first reference signal applied with the first set of masks, first masked channel information per mask of the first set of masks; and transmitting, to a user device, at least one of the following: the first masked channel information, or a first sidelink positioning reference signal configuration based on the first masked channel information.

According to another aspect, there is provided a computer readable medium comprising program instructions which, when executed by an apparatus, cause the apparatus to perform at least the following: applying a first set of masks to a first reference signal; measuring, from the first reference signal applied with the first set of masks, first masked channel information per mask of the first set of masks; and transmitting, to a user device, at least one of the following: the first masked channel information, or a first sidelink positioning reference signal configuration based on the first masked channel information.

According to another aspect, there is provided a non-transitory computer readable medium comprising program instructions which, when executed by an apparatus, cause the apparatus to perform at least the following: applying a first set of masks to a first reference signal; measuring, from the first reference signal applied with the first set of masks, first masked channel information per mask of the first set of masks; and transmitting, to a user device, at least one of the following: the first masked channel information, or a first sidelink positioning reference signal configuration based on the first masked channel information.

### LIST OF DRAWINGS

In the following, various example embodiments will be described in greater detail with reference to the accompanying drawings, in which

FIG. 1 illustrates an example of a cellular communication network;

FIG. 2 illustrates an example of a sidelink positioning scenario;

FIG. 3 illustrates a signaling diagram according to an example embodiment;

FIG. 4 illustrates a signaling diagram according to an example embodiment;

FIG. 5 illustrates a signaling diagram according to an example embodiment;

FIG. 6 illustrates a flow chart according to an example embodiment;

FIG. 7 illustrates a flow chart according to an example embodiment;

FIG. 8 illustrates an example of a reference signal in a slot;

FIG. 9 illustrates an example of a message; and

FIG. 10 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

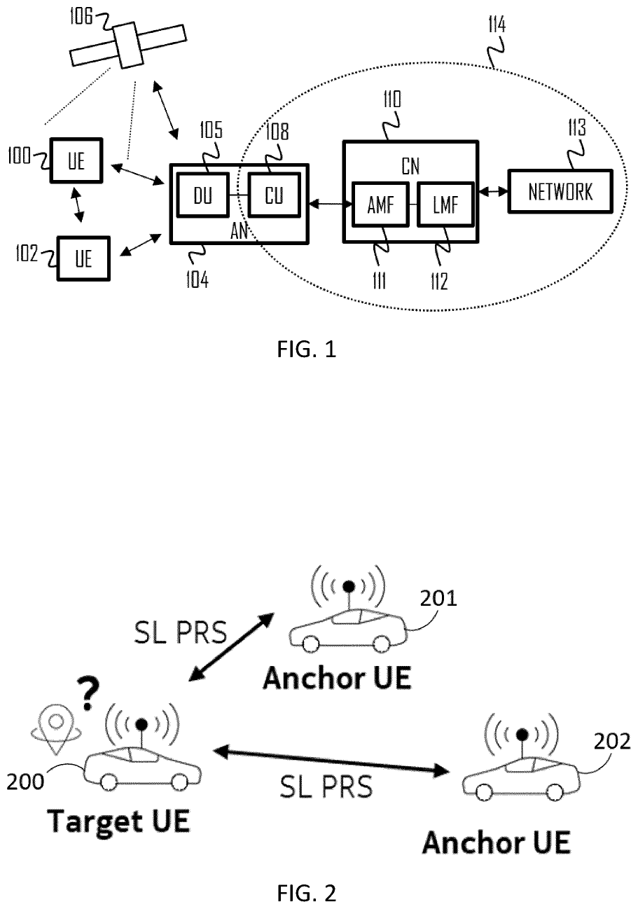

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

With respect to positioning, the service-based architecture (core network) may comprise an AMF 111 and a location management function (LMF) 112. The AMF may provide location information for call processing, policy, and charging to other network functions in the core network and to other entities requesting for positioning of terminal devices. The AMF may receive and manage location requests from several sources: mobile-originated location requests (MO-LR) from the user devices and mobile-terminated location requests (MT-LR) from other functions of the core network or from other network elements. The AMF may select the LMF for a given request and use its positioning service to trigger a positioning session. The LMF may then carry out the positioning upon receiving such a request from the AMF. The LMF may manage the resources and timing of positioning activities. The LMF may use a Namf_Communication service on an NL1 interface to request positioning of a user device from one or more access nodes, or the LMF may communicate with the user device over N1 for UE-based or UE-assisted positioning. The positioning may include estimation of a location and, additionally, the LMF may also estimate movement or accuracy of the location information when requested. Connection-wise, the AMF may be between the access node and the LMF and, thus, closer to the access nodes than the LMF.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHZ, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz—cmWave—mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or the like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (in a distributed unit, DU 105) and non-real time functions being carried out in a centralized manner (in a centralized unit, CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning technologies may be used to estimate a physical location of a user device. Herein the user device to be positioned is referred to as a target UE or target user device. For example, the positioning techniques used in NR may be based on at least one of the following: time difference of arrival (TDoA), round trip time (RTT), angle of departure (AoD), and/or angle of arrival (AoA).

In wireless positioning, multiple positioning anchors in known locations may transmit and/or receive one or more positioning reference signals (PRS) to/from the target UE. In the uplink, a sounding reference signal (SRS) may be used as a positioning reference signal. For example, multilateration techniques may then be used to localize (i.e., position) the target UE with respect to the positioning anchors. The positioning anchors may also be referred to as anchors, anchor nodes, multilateration anchors, or reference points herein. The positioning anchors may be, for example, radio access nodes (e.g., gNBs) or transmission and reception points (TRPs) (in uplink/downlink positioning), or other UEs (in sidelink positioning).

Sidelink (SL) positioning refers to the positioning approach, where the target UE utilizes the sidelink (i.e., the direct device-to-device link) to position itself, either in an absolute manner (in case of absolute positioning) or in a relative manner (in case of relative positioning). For UE-assisted positioning, the target UE may utilize the sidelink to obtain positioning measurements and report the measurements to a network entity such as a location management function (LMF). Sidelink positioning may also be used to obtain ranging information.

Ranging means determination of the distance between two UEs and/or the direction of one UE from the other one via direct device connection.

Absolute positioning means estimating the position of the target UE in two-dimensional or three-dimensional geographic coordinates (e.g., latitude, longitude, and/or elevation) within a coordinate system.

Relative positioning means estimating the position of the target UE relative to other network elements or relative to other UEs.

SL positioning may be based on the transmission of a sidelink positioning reference signal (SL PRS) by multiple anchor UEs, wherein the SL PRS is received and measured by a target UE to enable localization of the target UE within precise latency and accuracy requirements of the corresponding SL positioning session. Alternatively, or additionally, the target UE may transmit SL PRS to be received and measured by the anchor UEs.

An anchor UE may be defined as a UE supporting positioning of the target UE, for example by transmitting and/or receiving reference signals (e.g., SL PRS) for positioning over the SL interface. This may be similar to UL/DL-based positioning, where gNBs may serve as anchors transmitting and/or receiving reference signals to/from target UEs for positioning.

SL PRS refers to a reference signal transmitted over SL for positioning purposes.

FIG. 2 illustrates an example of a sidelink positioning scenario, where a target UE 200 is performing a sidelink positioning session, i.e., exchanging SL PRS with two anchor UEs 201, 202 in order to determine its location. Here, the anchor UEs 201, 202 are said to provide SL PRS assistance (including SL PRS) to the target UE 200.

Some example use cases for sidelink positioning may include (but are not limited to) vehicle-to-everything (V2X), public safety, commercial, and industrial internet of things (IIoT).

One of the advantages of sidelink positioning comes into play, when the target UE needs to be positioned outside the network coverage, or in scenarios having a limited number of radio access nodes or TRPs used as positioning anchors. Namely, sidelink positioning can be considered as a solution to improve the availability of positioning, for example, when Uu positioning is not available (e.g., the target UE is out of coverage), and when global navigation satellite system (GNSS) signals are not available (e.g., in places like tunnels, heavy urban scenarios, etc.).

With sidelink positioning, the target UE can make use of other UEs (or e.g., road-side units with SL interface), which serve as positioning anchors over SL. With the aid of SL, the target UE can be positioned under limited coverage or out-of-coverage scenarios. A road-side unit (RSU) may be defined as a UE-type or gNB-type stationary infrastructure entity supporting, for example, V2X applications.

Three network coverage scenarios (in coverage, partial coverage, and out of coverage) may be considered when at least two UEs are involved in sidelink positioning. Taking the case of two UEs as an example, the in-coverage scenario refers to the case where both UEs are inside the network coverage. Partial coverage means that one UE remains inside the network coverage, but the other UE is outside the network coverage. The out-of-coverage scenario refers to the case where both UEs are outside the network coverage. A UE may transit between in-coverage, partial coverage and out-of-coverage scenarios. For example, there may be V2X and public safety use cases that may require positioning, when there is no network coverage and no GNSS coverage.

There may be some positioning accuracy requirements for example for IIoT use cases in out-of-coverage scenarios. The positioning requirements may be captured via key performance indicators (KPIs), such as horizontal and vertical accuracy, positioning service availability, positioning service latency, time to first fix (TTFF), update rate, energy consumption, etc.

Vertical accuracy may refer to accuracy in altitude and may determine the floor for indoor use cases and to distinguish between superposed tracks for road and rail use cases (e.g., bridges).

Positioning service availability may be defined as a percentage value of the amount of time the positioning service is delivering the required position-related data within the performance requirements, divided by the amount of time the system is expected to deliver the positioning service according to the specification in the targeted service area.

Positioning service latency may be defined as the time elapsed between the event that triggers the determination of the position-related data and the availability of the position-related data at the system interface.

TTFF may be defined as the time elapsed between the event triggering for the first time the determination of the position-related data and the availability of the position-related data at the positioning system interface.

The performance requirements may be defined for different positioning service levels. Along with horizontal and vertical accuracy requirements, the requirements on positioning service availability and positioning service latency may be very stringent for positioning service levels 4 (99.9% availability and 15 ms latency) and 6 (99.9% availability and 10 ms latency).

The examples of scenarios or use cases for positioning service levels 4 and 6 may include V2X, set-2 and set-3 use cases. This may correspond to lane level positioning requirement use cases such as vehicle platooning, cooperative lane merge, lane change warning, emergency break warning, intersection movement assist, etc., and to below meter positioning requirement use cases such as high-definition sensor sharing, vulnerable road user (VRU)—collision risk warning, cooperative manoeuvers in emergency situations, real-time situation awareness and high-definition maps, etc.

For IIoT, the examples of scenarios or use cases for positioning service levels 4 and 6 may include Factories of the Future scenarios, such as augmented reality in smart factories, mobile control panels with safety functions in smart factories (within factory danger zones), inbound logistics for manufacturing (for driving trajectories, if supported by further sensors like camera, GNSS, inertial measurement unit, of indoor autonomous driving systems).

SL PRS may be configured in terms of various parameters. For example, an SL PRS (pre-)configuration may refer to (pre-)configured parameters of SL PRS, such as time-frequency resources including its bandwidth and periodicity; directivity-related parameters, e.g., beam direction, beam width, number of beams; and transmit power, etc.

In in-coverage or partial-coverage scenarios, the SL PRS (pre-) configuration may be determined by the network (e.g., LMF or gNB). In out-of-coverage scenarios, the SL PRS (pre-)configuration may be pre-configured and/or determined by UEs autonomously.

A resource pool (RP) is a set of resources assigned for SL procedures. There are two types of RPs: reception resource pools (Rx RPs) and transmission resource pools (Tx RPs). These may be signaled by the gNB for the in-coverage case, or preconfigured for the out-of-coverage case.

To transmit and receive data or control signaling over SL, UEs may utilize one of the following resource allocation modes: NR SL mode 1 (network-controlled mode), or NR SL mode 2 (UE-autonomous mode). In NR SL mode 1, the network allocates the SL resources for UEs. In NR SL mode 2, UEs autonomously select SL resources based on a sensing mechanism.

For NR SL mode 1, the UE may need to be in the RRC_CONNECTED state. For NR SL mode 2, the UE can also be in RRC_INACTIVE or RRC_IDLE state (e.g., when out of coverage), in addition to the possibility of operating in RRC_CONNECTED state.

NR SL transmissions may make use of a demodulation reference signal (DMRS) to enable the receiver UE to decode the associated SL physical channel, i.e., physical sidelink control channel (PSCCH), physical sidelink shared channel (PSSCH), or physical sidelink broadcast channel (PSBCH). Here, the DMRS is sent within the associated sidelink physical channel.

For demodulating the PSCCH, DMRS may be transmitted within the PSCCH. The PSCCH DMRS may follow the design of the DMRS associated with PDCCH in Rel. 15 NR Uu. The PSCCH DMRS may reuse the same pseudo-random sequence used for the PDCCH DMRS in Rel. 15 NR Uu, with the PSCCH DMRS sequence initialization based on a (pre-)configured value per resource pool. In addition, every PSCCH symbol may contain PSCCH DMRS. The pattern of PSCCH DMRS in the frequency domain may also reuse the DMRS frequency pattern employed for the PDCCH in Rel. 15 NR Uu.

For demodulating the PSSCH, DMRS may be sent within the PSSCH. The design of the PSSCH DMRS may follow some aspects of the DMRS associated with the physical uplink shared channel (PUSCH) in Rel. 15 NR Uu and others from PDSCH DMRS. The PSSCH DMRS may reuse the pseudo-random sequence used for the Rel. 15 PUSCH DMRS, with the sequence initialization based on a (pre-)configured value per resource pool. In the frequency domain, the type 1 pattern configuration of PDSCH DMRS may be employed for PSSCH DMRS.

For supporting different channel conditions, the DMRS associated with a PSSCH can be carried on different symbols, namely in 2, 3 or 4 SL symbols, within a PSSCH slot, i.e., with different time patterns. The different time patterns for the PSSCH DMRS may depend on the number of symbols for PSCCH, the number of symbols with PSSCH DMRS and the number of symbols for PSSCH within a slot. The time patterns currently supported for PSSCH DMRS in NR SL are listed in Table 1 below, where the position(s) of the DMRS symbols is given by l̅. Here, l_{d} is the duration of the scheduled resources for transmission of PSSCH and the associated PSCCH, including the orthogonal frequency-division multiplexing (OFDM) symbol duplicated. For a resource pool, one or more time patterns for PSSCH DMRS can be (pre-)configured. In case multiple patterns are (pre-)configured, the DMRS time pattern used in a PSSCH may be indicated in the associated 1st stage sidelink control information (SCI).

TABLE 1

| | DMRS position l̅ | | | | | |
|---|---|---|---|---|---|---|
| | PSCCH duration 2 symbols | | | PSCCH duration 3 symbols | | |
| l_{d} in | Number of PSSCH DMRS | | | Number of PSSCH DMRS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

As described above, SL positioning may be based on the SL PRS exchange between the target UE and anchor UE (e.g., in an RTT-based positioning technique), or transmissions of SL PRS by multiple anchor UEs that are to be received by a target UE (e.g., in a TDoA-based positioning technique) to enable localization of the target UE within precise latency and accuracy requirements of the corresponding SL positioning session. Here, the SL PRS reception quality at an anchor UE (in RTT-based techniques) and/or at the target UE may be a key factor that determines the achievable latency and accuracy performance for the SL positioning use cases. Hence, the configuration of resources for SL PRS transmission should ensure the desired SL PRS reception quality. In the following, the RTT-based SL positioning technique is considered as an example.

It is noted that in Uu-positioning, the LMF chooses, for example, a bandwidth (BW), a comb (frequency pattern) for that bandwidth, and a repetition (number of consecutive symbols) based on a coarse location estimate of the target UE. In other words, the LMF may be aware of the worst-case conditions that the target UE may experience, and dimensions the PRS accordingly, for example denser time allocation in bad signal-to-interference-plus-noise ratio (SINR) conditions, a comb proportional to coherence bandwidth, etc.

Unlike Uu-positioning, in SL positioning there may be no central entity (e.g., LMF) that is aware of the SL channel conditions and has control of the SL PRS configuration. Therefore, a target UE and/or anchor UE may need to autonomously select the SL PRS configuration for its SL PRS transmission (e.g., in RTT-based or TDoA-based schemes). In this regard, there is a challenge in how a target UE selects an appropriate SL PRS configuration for a given anchor UE, in particular when the target UE is not aware of the channel towards the anchor UE (e.g., in the initial stages of an SL positioning session). While the target UE may choose the most conservative SL PRS configuration to ensure high SL PRS reception quality, this may be resource-inefficient and therefore may not scale well for example in denser UE deployment scenarios.

Some example embodiments may provide a method, with which a target UE may select or adapt the SL PRS configuration to the link conditions between itself and a given anchor UE. The method may implement a closed-loop type of approach for tuning the SL PRS configuration to the propagation and interference conditions particular to a given radio link between the target UE and the anchor UE.

Some example embodiments may provide improved SL resource utilization (since there is no need for applying the most conservative SL PRS configuration to ensure high SL PRS reception quality), low latency and high accuracy SL positioning (since high SL PRS reception quality can be ensured even at early stages of the SL positioning session).

For example, some example embodiments may consider RTT-based SL positioning schemes, where SL PRS is exchanged between the target UE and anchor UE, and the target UE determines the SL PRS configuration. However, it should be noted that the problem and solution may be applicable to any SL positioning techniques, where an anchor UE, a target UE and/or a third UE (where a neighbouring third UE provides IUC-like information) needs to select an SL PRS configuration (either for its own SL PRS transmission or to provide IUC-like information to other UE transmitting SL PRS). IUC is an abbreviation for inter-UE coordination. With an aim to determine the appropriate SL PRS configuration that is suitable to the radio link conditions between a target UE and a given anchor UE, masked channel information (MCI) based determination of the SL PRS configuration may be utilized. Here, a set of RS masks may be defined on a set of reference signals (RS) to be transmitted between the target UE and anchor UE, where a given RS mask is designed to emulate an SL PRS, and hence the RS masking emulates the effect of sending multiple differently configured SL PRS, i.e., with different time/frequency/space patterns and densities.

Some example embodiments are described below using principles and terminology of 5G technology without limiting the example embodiments to 5G communication systems, however.

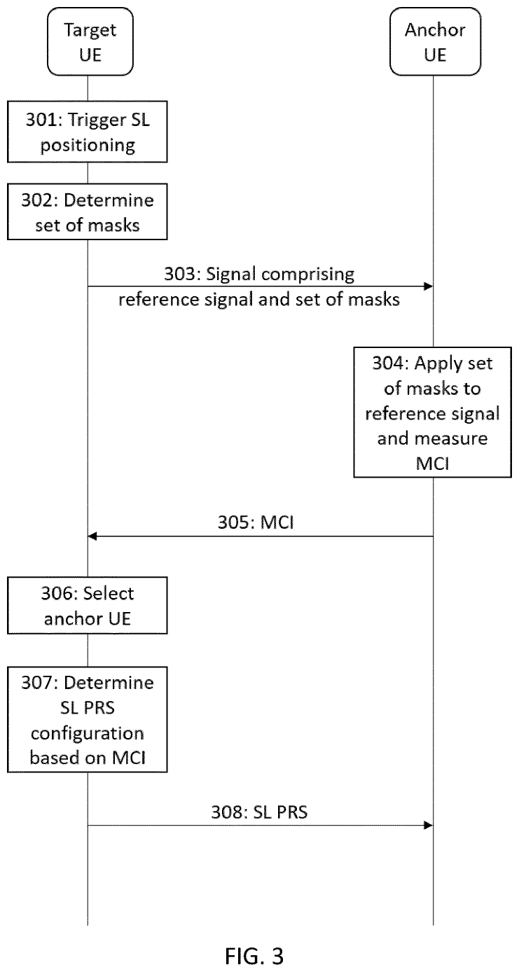

FIG. 3 illustrates a signaling diagram according to an example embodiment. In this example embodiment, an SL PRS configuration is selected at a target UE for its own SL PRS transmission. The target UE transmits to candidate anchor UE a message with a reference signal (RS) and a set of RS masks during the (re) establishment of an SL positioning session. Then, the candidate anchor UE applies the masks on the RS to compute MCI per mask, and responds to the target UE with the MCI. This MCI is used by the target UE to select the SL PRS configuration for its own SL PRS transmission.

Referring to FIG. 3, in block 301, an SL positioning session initiation is triggered at the target UE. This may be because of the localization needs of the involved uses cases (e.g., V2X). For example, an RTT-based SL positioning technique may be considered by the target UE.

In block 302, the target UE determines an RS mask configuration comprising at least a first set of masks (RS masks) which, when applied to a first reference signal at a candidate anchor UE, emulates a sidelink positioning reference signal (SL PRS) with multiple different SL PRS configurations. In other words, the RS masks are defined to emulate SL PRS when applied on the first reference signal, and different RS masking emulates the effect of sending differently configured SL PRS, i.e., with different time, frequency and space patterns and densities. The masking helps the target UE to anticipate how a given SL PRS configuration will impact the accuracy of the subsequent SL positioning measurements/estimates.

For example, the target UE may determine the first set of masks based on coarse ranging information to the candidate anchor UE (if previous SL communication happened). Otherwise, the target UE may select a mask by incrementally muting the resources from a minimum to a maximum muting pattern, where the minimum and maximum may be established based on a minimum or maximum coherence time and bandwidth. For example, for a minimum coherence bandwidth (denoted as minB), the minFreq comb=minB. Similarly, for a minimum coherence time (denoted as minTcoh), the min Time comb=minTcoh. The comb may mean a pattern defined in one or more of: time domain (e.g., symbols), frequency domain (e.g., subcarriers) and/or one or more space domain (e.g., beams).

Herein an SL PRS configuration may refer to a set of parameters that establish the RS pattern in at least the following domains: frequency, time and space (e.g., transmit beams and/or receive beams).

A given mask of the first set of masks may comprise a binary (Boolean) matrix which, when applied to a matrix of the first reference signal (RS samples matrix), mutes one or more entries (i.e., some entries) of the matrix of the first reference signal. The binary matrix (mask) may be a two-dimensional matrix or a multi-dimensional matrix. That is, the binary matrix (mask) may comprise two or more dimensions.

Let M denote the first set of masks determined by the target UE, where the i-th entry M(i) describes how the i-th mask should be generated and applied on the first reference signal. For example, a given mask M(i) of the first set of masks may be defined by a combination of at least the following: a comb in time domain, a comb in frequency domain, and a comb in space domain. The comb in time domain may mean a time pattern, for example selecting every x-th symbol of the first reference signal. The comb in frequency domain may mean a frequency pattern, for example selecting every x-th subcarrier of the first reference signal for the symbol (x). The comb in space domain may mean a spatial pattern, for example selecting transmit beams b1, b2, . . . and receive beams r1, r3, . . . , for the symbol (x).

In other words, if an entry in the mask is 1, i.e., M(i) [f, x, b, r]=1, then the RS sample at frequency f, symbol x, transmit beam b, and receive beam r is to be used for computing MCI(i). Conversely, if the entry is 0, then the corresponding RS sample is not used when computing MCI(i). Herein the term “symbol” may refer to an OFDM symbol.

A non-limiting example of applying a mask is provided in the following:

$$mask = [ \begin{matrix}1 & 0 \\ 0 & 0\end{matrix} ]$$

applied onto RS samples matrix

$$RS = [ \begin{matrix}rs ( {f}_{1} , {t}_{1} ) & rs ( {f}_{1} , {t}_{2} ) \\ rs ( {f}_{2} , {t}_{1} ) & rs ( {f}_{2} , {t}_{2} )\end{matrix} ]$$

$$produces an output = mask \times RS = [ \begin{matrix}rs ( {f}_{1} , {t}_{1} ) & 0 \\ 0 & 0\end{matrix} ] ,$$

where f₁ and f₂ may denote an index of a subcarrier number, and t₁ and t₂ may denote an index of the OFDM symbol number or sample number.

In block 303, the target UE transmits, to one or more candidate anchor UEs (FIG. 3 shows only one anchor UE and the other UEs are unshown but they may exist), a message comprising the first reference signal and the first set of masks. Herein the term “candidate anchor UE” may refer to a UE that is not yet active in the SL positioning session of the target UE. In other words, the one or more candidate anchor UEs may not yet be transmitting SL PRS to the target UE or measuring SL PRS transmitted by the target UE. For example, the first reference signal may comprise a DMRS.

The message may also comprise a request for measuring and reporting MCI using the first set of masks. The MCI has been measured by using the first set of masks may also be referred to as the first masked channel information herein.

The message may be transmitted as a SL broadcast message over a SL slot with a configuration, where some symbols are used for RS transmission, while the other symbols are carrying data. The data symbols payload may comprise: the SL positioning request (and the session KPIs, such as latency target), type of positioning technique(s) used in the SL positioning session (e.g., TDoA, RTT, etc.), the first set of masks M, where the i-th entry M(i) describes how the i-th mask should be generated and applied on the RS part of the SL signal, and the request to measure MCI using the masks in the first set of masks M.

For example, to initiate the RTT-based SL positioning technique, the target UE may send an anchor discovery solicitation message, denoted as Msg-A, to find/discover suitable anchor UEs in the vicinity. To provide the RS mask configuration (first set of masks) to the one or more candidate anchor UEs, the target UE may include the mask configuration in the Msg-A. Also, an SL PRS (from which different SL PRS configurations can be obtained by using the mask) may be embedded in the Msg-A. In addition, the target UE may embed in the Msg-A the request for the candidate anchor UE to respond with MCI. In other words, the message comprising the first reference signal and the first set of masks (and the request) may refer to the anchor discovery solicitation message (Msg-A). An example of the structure of Msg-A is illustrated in FIG. 9.

In block 304, the one or more candidate anchor UEs receive the request, decode the payload, and evaluate the request. In case of positive outcome (i.e., if a given candidate anchor UE determines to support the SL positioning session of the target UE), the candidate anchor UE applies the first set of masks as per the indicated mask configuration to the first reference signal to measure, or compute, the first masked channel information per mask of the first set of masks from the first reference signal applied with the first set of masks.

The first masked channel information may comprise at least one of the following: reference signal received power (RSRP), received signal strength indicator (RSSI), channel frequency response (CFR), or channel impulse response (CIR) measured from the first reference signal applied (i.e., combined) with the first set of masks.

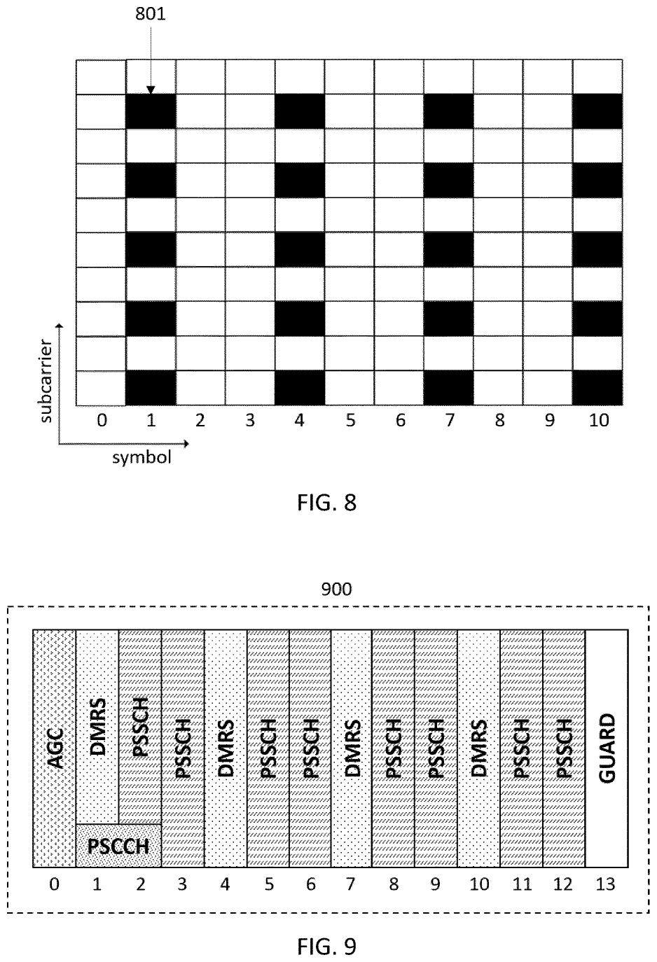

Applying the first set of masks to the first reference signal may comprise applying the binary matrix per mask to the matrix of the first reference signal, for example by multiplying the binary matrix (mask) and the matrix of the first reference signal. That is, the indicated mask, i.e., a binary (Boolean) matrix is combined on top of the RS samples matrix of the first reference signal for example as described above for block 302. An example of the RS, to which the masks are applied, is illustrated in FIG. 8. On the masked RS samples (upon applying the masks M on the RS as instructed), the candidate anchor UE measures, or computes, MCI per mask M(i).

For example, a given candidate anchor UE may sample the first reference signal and arrange the samples in a matrix Mrs, where Mrs(f,t,s,r) designates the RS sample at time t, subcarrier f, transmit beam s, and receive beam r. For a given mask “i”, the candidate anchor UE may compute a masked RS matrix Mmrs=Mrs×M(i), and use Mmrs to extract MCI(i).

In block 305, (in case of positive outcome from the evaluation) the one or more candidate anchor UEs transmit, to the target UE, the first masked channel information. A given candidate anchor UE may respond to the request with an SL unicast message, wherein the payload of the message may be encoded with at least: the location and location certainty of the candidate anchor UE, and the first masked channel information MCI(i) per mask M(i).

For example, a given candidate anchor UE may respond to the request in the Msg-A by sending an anchor discovery response message, denoted as Msg-B, to the target UE (e.g., in a unicast manner). In Msg-B, the candidate anchor UE may include at least: its own location and location certainty, and the first masked channel information MCI(i) per mask M(i).

Alternatively, or additionally, the one or more candidate anchor UEs may determine a preferred SL PRS configuration based on the first masked channel information, and transmit the preferred SL PRS configuration to the target UE instead of or in addition to the first masked channel information.

In other words, the one or more candidate anchor UEs may transmit, to the target UE, at least one of the following: the first masked channel information, or a preferred sidelink positioning reference signal configuration based on the first masked channel information. The preferred sidelink positioning reference signal configuration may also be referred to as a first sidelink positioning reference signal configuration.

In block 306, the target UE performs anchor UE selection for example based on the received Msg-B. In other words, the target UE may select at least one anchor UE from the one or more candidate anchor UEs to support its SL positioning session.

In block 307, the target UE determines, or selects, the first sidelink positioning reference signal configuration based at least partly on the first masked channel information (e.g., RSRP, RSSI, CFR and/or CIR, etc.) received from the selected at least one anchor UE, or based on the preferred sidelink positioning reference signal configuration received from the selected at least one anchor UE. This way, the target UE may determine or select an SL PRS configuration that is suitable for the radio link between the target UE and the at least one selected anchor UE.

The first sidelink positioning reference signal configuration may be determined based further, at least partly, on a mapping of the first masked channel information and one or more sidelink positioning reference signal parameter settings. In other words, the target UE may use the received MCI list and an internal mapping between MCI and SL PRS parameter setting to select a suitable SL PRS configuration for the anchor UE. For example, the mapping may be given in a tabular form as presented in Table 2 below. In Table 2, the positioning requirement level (e.g., Pos_Req_1, Pos_Req_2, etc.) captures the requirement, for example positioning accuracy requirement, of the involved positioning use case. For a given MCI range (e.g., Range 1, Range 2, etc.), different accuracy requirements may map to different SL PRS parameters settings (i.e., SL PRS configurations), such as frequency patterns and time patterns.

Such a table may be autonomously populated by the target UE, or it may be provided by the network or another UE (e.g., anchor UE or neighboring UE). Depending on the session type, number of responsive candidate anchor UEs and their availability, the target UE may further refine the SL PRS parameter setting output by the table search. The table may be known by both the target UE and the one or more candidate anchor UEs. In this case, the one or more candidate anchor UEs may indicate their preferred SL PRS configuration instead of or in addition to the MCI in block 305.

TABLE 2

| | Positioning | |
|---|---|---|
| MCI range | requirement level | SL PRS parameter setting |
| Range 1 | Pos_Req_1 | (frequency_pattern_1_1, |
| | | time_pattern_1_1, BW_1_1) |
| Range 1 | Pos_Req_2 | (frequency_pattern_1_2, |
| | | time_pattern_1_2, BW_1_2) |
| . . . | . . . | . . . |
| Range 2 | Pos_Req_1 | (frequency_pattern_2_1, |
| | | time_pattern_2_1, BW_2_1) |
| . . . | . . . | . . . |

In block 308, the target UE transmits a first sidelink positioning reference signal to the at least one selected anchor UE based on the first sidelink positioning reference signal configuration. In other words, the target UE applies the selected SL PRS configuration to its own SL PRS transmission. The at least one selected anchor UE receives and measures the first sidelink positioning reference signal to support the SL positioning session of the target UE.

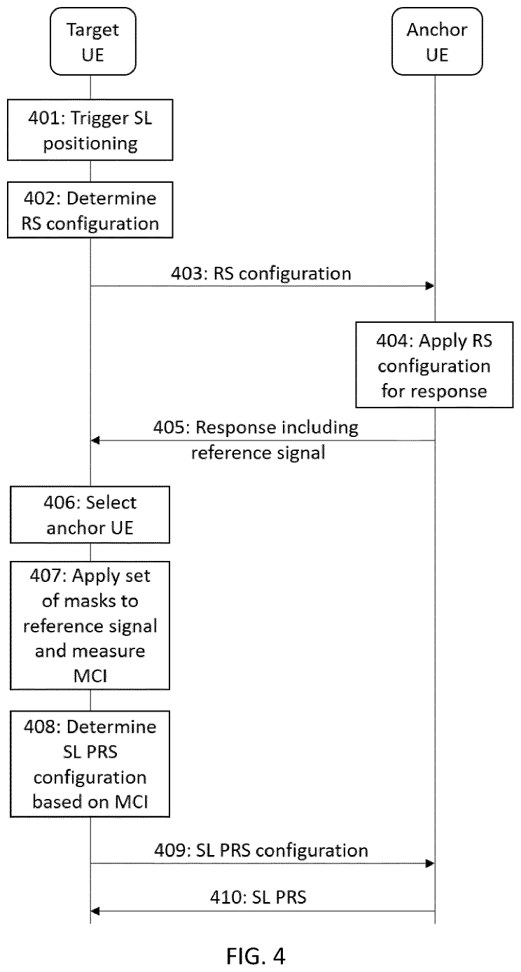

FIG. 4 illustrates a signaling diagram according to an example embodiment. In this example embodiment, an SL PRS configuration is selected at a target UE for an anchor UE's SL PRS transmission. Here, the target UE provides an RS configuration for the response message from the anchor UE. Subsequently, the anchor UE responds with a reference signal as per the indicated RS configuration. Then, the target UE applies RS masks on the RS transmitted by the anchor UE to compute MCI. This MCI is used to select a suitable SL PRS configuration for the anchor UE's SL PRS transmission. Then, the target UE indicates the selected SL PRS configuration to the anchor UE, so that the anchor UE can use the suitable SL PRS configuration for its SL PRS transmission.

Referring to FIG. 4, in block 401, an SL positioning session initiation is triggered at the target UE. This may be because of the localization needs of the involved uses cases (e.g., V2X). For example, an RTT-based SL positioning technique may be considered by the target UE.

In block 402, the target UE determines a reference signal configuration. This reference signal configuration may be referred to as a configuration for a first reference signal. Herein a configuration may refer to a set of parameters that establish the RS pattern in at least the following domains: frequency, time and space (e.g., transmit beams and/or receive beams).

In block 403, the target UE transmits, to the one or more candidate UEs, the configuration for the first reference signal. For example, to initiate the RTT-based SL positioning, the target UE may send an anchor discovery solicitation message (denoted as Msg-A), to find/discover suitable anchor UEs in the vicinity. In Msg-A, the target UE may include the reference signal configuration determined in block 402. The Msg-A may also comprise a request to respond with the first reference signal.

In block 404, the one or more candidate anchor UEs receive the Msg-A, decode the payload, and evaluate the request. In case of positive outcome (i.e., if a given candidate anchor UE determines to support the SL positioning session of the target UE), the candidate anchor UE applies the reference signal configuration for its response message.

In block 405, (in case of positive outcome from the evaluation) the one or more candidate anchor UEs respond to the target UE by transmitting the first reference signal to the target UE according to the reference signal configuration received from the target UE. For example, a given candidate anchor UE may respond to the request by sending an anchor discovery response message (denoted as Msg-B) to the target UE (e.g., in a unicast manner), wherein the Msg-B also comprises the first reference signal. For example, the first reference signal may be a DMRS.

In block 406, the target UE performs anchor UE selection for example based on the received Msg-B. In other words, the target UE may select at least one anchor UE from the one or more candidate anchor UEs to support its SL positioning session.

In block 407, the target UE determines and applies a first set of masks to the first reference signal received from the selected at least one anchor UE, and measures first masked channel information per mask of the first set of masks from the first reference signal applied with the first set of masks.

The first masked channel information may comprise at least one of the following: reference signal received power (RSRP), received signal strength indicator (RSSI), channel frequency response (CFR), or channel impulse response (CIR) measured from the first reference signal applied with the first set of masks.

A given mask of the first set of masks may comprise a binary (Boolean) matrix which, when applied to a matrix of the first reference signal (RS samples matrix), mutes one or more entries (i.e., some entries) of the matrix of the first reference signal. The binary matrix (mask) may be a two-dimensional matrix or a multi-dimensional matrix. That is, the binary matrix (mask) may comprise two or more dimensions.

Let M denote the first set of masks, where the i-th entry M(i) describes how the i-th mask should be generated and applied on the first reference signal. For example, a given mask M(i) of the first set of masks may be defined by a combination of at least the following: a comb in time domain, a comb in frequency domain, and a comb in space domain. The comb in time domain may mean a time pattern, for example selecting every x-th symbol of the first reference signal. The comb in frequency domain may mean a frequency pattern, for example selecting every y-th subcarrier of the first reference signal for the symbol (x). The comb in space domain may mean a spatial pattern, for example selecting transmit beams b1, b2, . . . and receive beams r1, r3, . . . , for the symbol (x).

On the masked RS samples (i.e., the RS resulting from applying the masks M on the received DMRS), the target UE computes MCI per mask M(i). In other words, if an entry in the mask is 1, i.e., M(i) [f, x, b, r]=1, then the RS sample at frequency f, symbol x, transmit beam b, and receive beam r is to be used for computing MCI(i). Conversely, if the entry is 0, then the corresponding RS sample is not used when computing MCI(i). Herein the term “symbol” may refer to an OFDM symbol.

A non-limiting example of applying a mask is provided in the following:

$$mask = [ \begin{matrix}1 & 0 \\ 0 & 0\end{matrix} ]$$

applied onto RS samples matrix

$$RS = [ \begin{matrix}rs ( {f}_{1} , {t}_{1} ) & rs ( {f}_{1} , {t}_{2} ) \\ rs ( {f}_{2} , {t}_{1} ) & rs ( {f}_{2} , {t}_{2} )\end{matrix} ]$$

$$produces an output = mask \times RS = [ \begin{matrix}rs ( {f}_{1} , {t}_{1} ) & 0 \\ 0 & 0\end{matrix} ] ,$$

where f₁ and f₂ may denote an index of a subcarrier number, and t₁ and t₂ may denote an index of the OFDM symbol number or sample number.

In block 408, the target UE determines, or selects, a first sidelink positioning reference signal configuration based at least partly on the first masked channel information (e.g., RSRP, RSSI, CFR and/or CIR, etc.) measured by the target UE. This way, the target UE may determine or select an SL PRS configuration that is suitable for the radio link between the target UE and the selected at least one anchor UE.

In block 409, the target UE transmits the first sidelink positioning reference signal configuration to the selected at least one anchor UE, so that the selected at least one anchor UE can use the suitable SL PRS configuration for its SL PRS transmission.

In block 410, the selected at least one anchor UE transmits a sidelink positioning reference signal to the target UE based on the first sidelink positioning reference signal configuration. The target UE receives and measures the first sidelink positioning reference signal from the selected at least one anchor UE for the SL positioning session of the target UE.

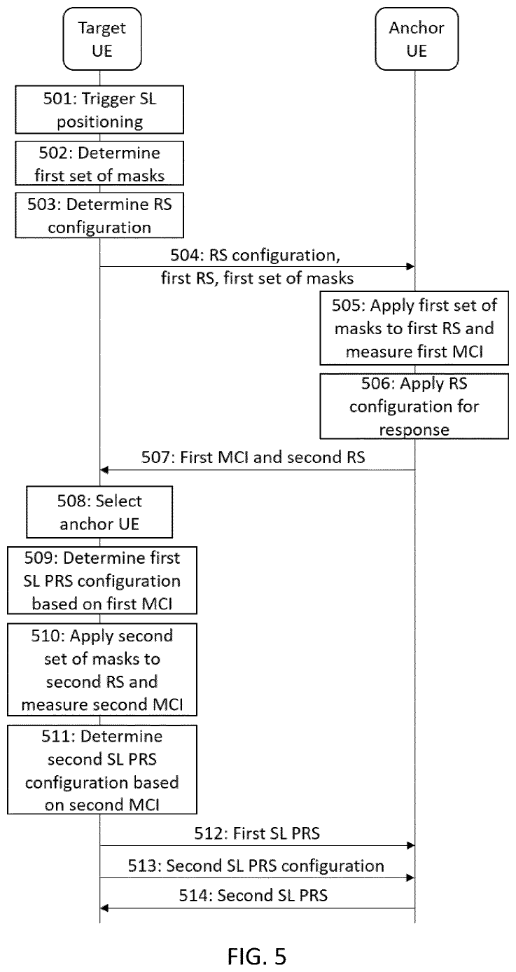

FIG. 5 illustrates a signaling diagram according to an example embodiment. In this example embodiment, the target UE selects an SL PRS configuration for its own SL PRS transmission, and an SL PRS configuration for an anchor UE's SL PRS transmission. Here, the target UE sends to candidate anchor UE a message with RS, a first set of RS masks, and RS configuration for the response message during the (re) establishment of an SL positioning session. The candidate anchor UE applies the masks on the RS to compute first MCI per mask, and responds to the target UE with the first MCI. Also, the response includes an RS as per the indicated RS configuration. The target UE uses the received first MCI to select a suitable SL PRS configuration for its own SL PRS transmission. In addition, the target UE applies a second set of RS masks on the RS transmitted by the anchor UE to compute second MCI. This second MCI is used to select a suitable SL PRS configuration for the anchor UE's SL PRS transmission. Then, the target UE indicates the selected SL PRS configuration to the anchor UE, so that the anchor UE can use the suitable SL PRS configuration for its SL PRS transmission.

Referring to FIG. 5, in block 501, an SL positioning session initiation is triggered at the target UE. This may be because of the localization needs of the involved uses cases (e.g., V2X). For example, an RTT-based SL positioning technique may be considered by the target UE.

In block 502, the target UE determine a first RS mask configuration comprising at least a first set of masks (RS masks) which, when applied to a first reference signal at a candidate anchor UE, emulates a sidelink positioning reference signal (SL PRS) with multiple different SL PRS configurations. In other words, the RS masks are defined to emulate SL PRS when applied on the first reference signal, and different RS masking emulates the effect of sending differently configured SL PRS, i.e., with different time, frequency and space patterns and densities.

Herein an SL PRS configuration may refer to a set of parameters that establish the RS pattern in at least the following domains: frequency, time and space (e.g., transmit beams and/or receive beams).

A given mask of the first set of masks may comprise a binary (Boolean) matrix which, when applied to a matrix of the first reference signal (RS samples matrix), mutes one or more entries (i.e., some entries) of the matrix of the first reference signal. The binary matrix (mask) may be a two-dimensional matrix or a multi-dimensional matrix. That is, the binary matrix (mask) may comprise two or more dimensions.

In block 503, the target UE determines a reference signal configuration. This reference signal configuration may be referred to as a configuration for a second reference signal.

In block 504, the target UE transmits, to the one or more candidate UEs, a message comprising the first reference signal, the first set of masks, and the configuration for the second reference signal. For example, to initiate the RTT-based SL positioning, the target UE may send an anchor discovery solicitation message (denoted as Msg-A), to find/discover suitable anchor UEs in the vicinity. The Msg-A may comprise the first reference signal, the first set of masks, and the configuration for the second reference signal. The Msg-A may also comprise a request to respond with the second reference signal and first MCI measured using the first set of masks. An example of the structure of Msg-A is illustrated in FIG. 9. Alternatively, the first reference signal, the first set of masks, the configuration for the second reference signal, and the request may be transmitted separately instead of in a single message.

In block 505, the one or more candidate anchor UEs receive the Msg-A, decode the payload, and evaluate the request. In case of a positive outcome (i.e., if a given candidate anchor UE determines to support the SL positioning session of the target UE), the candidate anchor UE applies the first set of masks to the first reference signal to measure, or compute, first masked channel information per mask of the first set of masks from the first reference signal applied with the first set of masks.

The first masked channel information may comprise at least one of the following: reference signal received power (RSRP), received signal strength indicator (RSSI), channel frequency response (CFR), or channel impulse response (CIR) measured from the first reference signal applied with the first set of masks.

Applying the first set of masks to the first reference signal may comprise applying the binary matrix per mask to the matrix of the first reference signal. That is, the indicated mask, i.e., a binary (Boolean) matrix is applied on top of the RS samples matrix of the first reference signal. An example of the RS, to which the masks are applied, is illustrated in FIG. 8. On the masked RS samples (upon applying the masks M on the RS as instructed), the candidate anchor UE measures, or computes, MCI per mask M(i).

For example, a given candidate anchor UE may sample the first reference signal and arrange the samples in a matrix Mrs, where Mrs(f,t,s,r) designates the RS sample at time t, subcarrier f, transmit beam s, receive beam r. For a given mask “i”, the candidate anchor UE may compute a masked RS matrix Mmrs=Mrs×M(i), and use Mmrs to extract MCI(i).

In block 506, in case of a positive outcome from the evaluation (i.e., if a given candidate anchor UE determines to support the SL positioning session of the target UE), the candidate anchor UE applies the reference signal configuration for its response message.

In block 507, (in case of positive outcome from the evaluation) the one or more candidate anchor UEs respond to the target UE by transmitting the first masked channel information, and the second reference signal (e.g., DMRS) according to the reference signal configuration received from the target UE. For example, a given candidate anchor UE may respond to the request by sending an anchor discovery response message (denoted as Msg-B) to the target UE (e.g., in a unicast manner), wherein the Msg-B may comprise the first MCI and the second reference signal. Alternatively, the first MCI and the second reference signal may be transmitted separately instead of in a single message.

In block 508, the target UE performs anchor UE selection for example based on the received Msg-B. In other words, the target UE may select at least one anchor UE from the one or more candidate anchor UEs to support its SL positioning session.

In block 509, the target UE determines, or selects, a first sidelink positioning reference signal configuration for its own SL PRS transmission based at least partly on the first masked channel information (e.g., RSRP, RSSI, CFR and/or CIR, etc.) received from the selected at least one anchor UE.

In block 510, the target UE applies a second set of masks to the second reference signal received from the selected at least one anchor UE, and measures second masked channel information per mask of the second set of masks from the second reference signal applied with the second set of masks.

The second masked channel information may comprise at least one of the following: reference signal received power (RSRP), received signal strength indicator (RSSI), channel frequency response (CFR), or channel impulse response (CIR) measured from the second reference signal applied with the second set of masks.

A given mask of the second set of masks may comprise a binary (Boolean) matrix which, when applied to a matrix of the second reference signal (RS samples matrix), mutes one or more entries (i.e., some entries) of the matrix of the second reference signal. The binary matrix (mask) may be a two-dimensional matrix or a multi-dimensional matrix. That is, the binary matrix (mask) may comprise two or more dimensions.

In block 511, the target UE determines, or selects, a second sidelink positioning reference signal configuration for the anchor UE's SL PRS transmission based at least partly on the second masked channel information (e.g., RSRP, RSSI, CFR and/or CIR, etc.) measured by the target UE.

In block 512, the target UE transmits a first sidelink positioning reference signal to the at least one selected anchor UE based on the first sidelink positioning reference signal configuration. In other words, the target UE applies the first SL PRS configuration to its own SL PRS transmission. The at least one selected anchor UE receives and measures the first sidelink positioning reference signal to support the SL positioning session of the target UE.

In block 513, the target UE transmits the second sidelink positioning reference signal configuration to the selected at least one anchor UE, so that the selected at least one anchor UE can use the second SL PRS configuration for its SL PRS transmission.

In block 514, the selected at least one anchor UE transmits a second sidelink positioning reference signal to the target UE based on the second sidelink positioning reference signal configuration received from the target UE. The target UE receives and measures the second sidelink positioning reference signal from the selected at least one anchor UE for the SL positioning session of the target UE.

Herein the terms “first sidelink positioning reference signal” and “second sidelink positioning reference signal” are used to distinguish the sidelink positioning reference signals, and they do not necessarily mean a specific order of the sidelink positioning reference signals. Similarly, the terms “first sidelink positioning reference signal configuration” and “second sidelink positioning reference signal configuration” are used to distinguish the SL PRS configurations, and they do not necessarily mean a specific order of determining the SL PRS configurations.

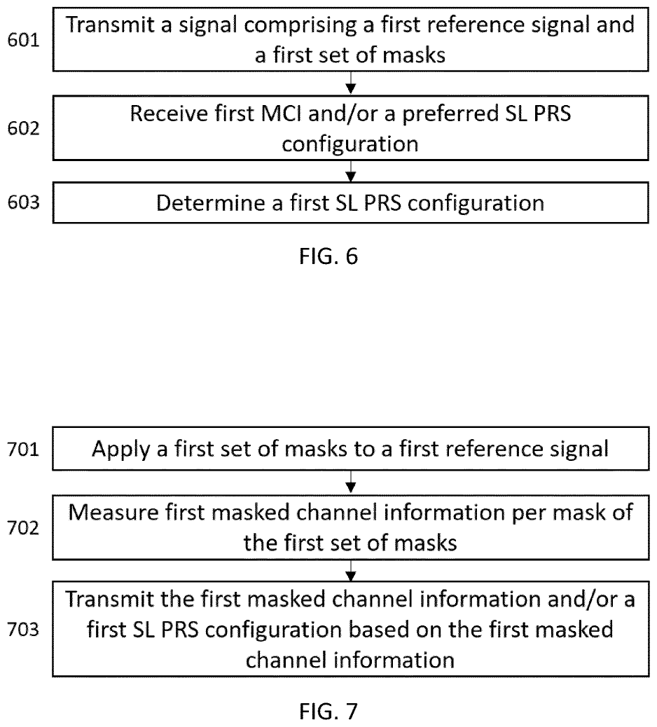

FIG. 6 illustrates a flow chart according to an example embodiment of a method performed by an apparatus such as, or comprising, or comprised in, a user device. The user device may also be called a subscriber unit, mobile station, remote terminal, access terminal, user terminal, terminal device, user equipment (UE), target UE, or target user device. The user device may correspond to one of the user devices 100, 102 of FIG. 1, or to the target UE 200 of FIG. 2.

Referring to FIG. 6, in block 601, a message comprising a first reference signal and a first set of masks is transmitted to one or more user devices. The one or more user devices may comprise one or more anchor UEs or one or more candidate anchor UEs.

In block 602, at least one of the following is received from the one or more user devices: first masked channel information per mask of the first set of masks, or a preferred sidelink positioning reference signal configuration based on the first masked channel information.

In block 603, a first sidelink positioning reference signal configuration is determined based at least partly on the first masked channel information or the preferred sidelink positioning reference signal configuration.

FIG. 7 illustrates a flow chart according to an example embodiment of a method performed by an apparatus such as, or comprising, or comprised in, a user device. The user device may also be called a subscriber unit, mobile station, remote terminal, access terminal, user terminal, terminal device, user equipment (UE), anchor UE, candidate anchor UE, target UE, or target user device. The user device may correspond to one of the user devices 100, 102 of FIG. 1, or to the target UE 200 of FIG. 2, or to one of the anchor UEs 201, 202 of FIG. 2.

Referring to FIG. 7, in block 701, a first set of masks is applied to a first reference signal. Herein applying the first set of masks to the first reference signal may mean combining the first reference signal with a given mask of the first set of masks.

In block 702, first masked channel information is measured, per mask of the first set of masks, from the first reference signal applied with the first set of masks.

In block 703, at least one of the following is transmitted to a user device (e.g., to a target UE or an anchor UE): the first masked channel information, or a first sidelink positioning reference signal configuration based on the first masked channel information.

The blocks, related functions, and information exchanges (messages) described above by means of FIGS. 3-7 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIG. 8 illustrates an example of the RS pattern of an SL signal, on which the masks may be applied to obtain masked RS samples that emulate differently configured SL PRS. In FIG. 8, a given black box 801 represents a resource element (RE) carrying RS.

FIG. 9 illustrates an example of the structure 900 of Msg-A with a PSCCH duration of 2 symbols, the number of 4 PSSCH DMRS, the guard period ((la) in symbol 13 in Table 1 above, where PSSCH-DMRS is used as SL PRS. In FIG. 9, a PSSCH symbol with DMRS is shown as DMRS. In the Msg-A, along with the anchor discovery solicitation message, the payload transmitted in PSSCH symbols may include, for example, at least: an RS mask configuration (a set of masks M), and a request to measure MCI using the masks in the set M. MCI may mean any combination of: RSRP, RSSI, CFR, CIR, etc. In FIG. 9, AGC is an abbreviation for automatic gain control and the AGC is used to regulate the signal strength. The numbers 0-13 in FIG. 9 refer to symbols in time domain.

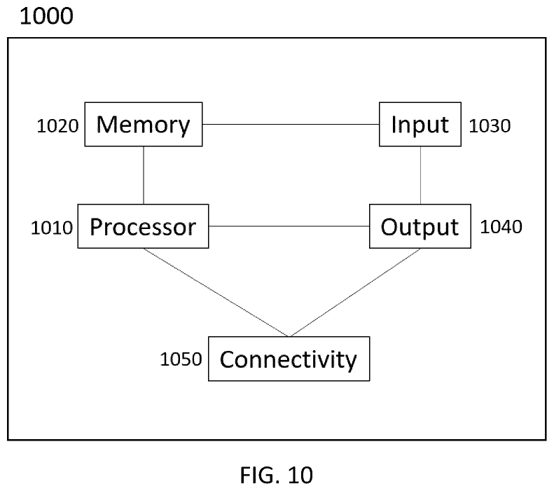

FIG. 10 illustrates an example of an apparatus 1000 comprising means for performing any of the methods of FIG. 3 to FIG. 7, or any other example embodiment described above. For example, the apparatus 1000 may be an apparatus such as, or comprising, or comprised in, a user device. The user device may correspond to one of the user devices 100, 102 of FIG. 1, or one of the user devices 200, 201, 202 of FIG. 2. The user device may also be called a subscriber unit, mobile station, remote terminal, access terminal, user terminal, terminal device, user equipment (UE), anchor UE, candidate anchor UE, target UE, or target user device.

The apparatus 1000 comprises at least one processor 1010. The at least one processor 1010 interprets instructions (or, computer program instructions) and processes data. The at least one processor 1010 may comprise one or more programmable processors. The at least one processor 1010 may comprise programmable hardware with embedded firmware and may, alternatively or additionally, comprise one or more application-specific integrated circuits (ASICs).

The at least one processor 1010 is coupled to at least one memory 1020. The at least one processor is configured to read and write data to and from the at least one memory 1020. The at least one memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1020 stores computer readable instructions that are executed by the at least one processor 1010 to perform one or more of the example embodiments described above. For example, non-volatile memory stores the computer readable instructions, and the at least one processor 1010 executes the instructions using volatile memory for temporary storage of data and/or instructions. The computer readable instructions may refer to computer program code.

The computer readable instructions may have been pre-stored to the at least one memory 1020 or, alternatively or additionally, they may be received, by the apparatus, via an electromagnetic carrier signal and/or may be copied from a physical entity such as a computer program product. Execution of the computer readable instructions by the at least one processor 1010 causes the apparatus 1000 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1000 may further comprise, or be connected to, an input unit 1030. The input unit 1030 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1030 may comprise an interface to which external devices may connect to.

The apparatus 1000 may also comprise an output unit 1040. The output unit may comprise or be connected to one or more displays capable of rendering visual content, such as a light emitting diode (LED) display, a liquid crystal display (LCD) and/or a liquid crystal on silicon (LCoS) display. The output unit 1040 may further comprise one or more audio outputs. The one or more audio outputs may be for example loudspeakers.

The apparatus 1000 further comprises a connectivity unit 1050. The connectivity unit 1050 enables wireless connectivity to one or more external devices. The connectivity unit 1050 comprises at least one transmitter and at least one receiver that may be integrated to the apparatus 1000 or that the apparatus 1000 may be connected to. The at least one transmitter comprises at least one transmission antenna, and the at least one receiver comprises at least one receiving antenna. The connectivity unit 1050 may comprise an integrated circuit or a set of integrated circuits that provide the wireless communication capability for the apparatus 1000. Alternatively, the wireless connectivity may be a hardwired application-specific integrated circuit (ASIC). The connectivity unit 1050 may also provide means for performing at least some of the blocks for one or more example embodiments described above. The connectivity unit 1050 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1000 may further comprise various components not illustrated in FIG. 10. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1.-18. (canceled)

19. An apparatus comprising:
at least one processor, and at least one memory storing instructions which, when executed by the at least one processor, cause the apparatus at least to:
transmit, to one or more user devices, a message comprising a first reference signal and a first set of masks;
receive, from the one or more user devices, at least one of the following: first masked channel information per mask of the first set of masks, or a preferred sidelink positioning reference signal configuration based on the first masked channel information; and
determine a first sidelink positioning reference signal configuration based at least partly on the first masked channel information or the preferred sidelink positioning reference signal configuration.

20. The apparatus according to claim 19, further being caused to:
determine the first set of masks which, when applied to the first reference signal, emulate a sidelink positioning reference signal with multiple different configurations.

21. The apparatus according to claim 19, wherein a mask of the first set of masks comprises a binary matrix which, when applied to a matrix of the first reference signal, mutes one or more entries of the matrix of the first reference signal.

22. The apparatus according to claim 21, wherein the mask is defined by a combination of at least the following: a comb in time domain, a comb in frequency domain, and a comb in space domain.

23. The apparatus according to claim 19, further being caused to:
transmit, to the one or more user devices, a request for measuring the first masked channel information using the first set of masks.

24. The apparatus according to claim 19, wherein the first masked channel information comprises at least one of the following: reference signal received power, received signal strength indicator, channel frequency response, or channel impulse response measured from the first reference signal applied with the first set of masks.

25. The apparatus according to claim 19, wherein the first sidelink positioning reference signal configuration is determined based at least partly on a mapping of the first masked channel information and one or more sidelink positioning reference signal parameter settings.

26. A method comprising:
transmitting, to one or more user devices, a message comprising a first reference signal and a first set of masks;
receiving, from the one or more user devices, at least one of the following: first masked channel information per mask of the first set of masks, or a preferred sidelink positioning reference signal configuration based on the first masked channel information; and
determining a first sidelink positioning reference signal configuration based at least partly on the first masked channel information or the preferred sidelink positioning reference signal configuration.

27. The method according to claim 26, further comprising:
determining the first set of masks which, when applied to the first reference signal, emulate a sidelink positioning reference signal with multiple different configurations.

28. The method according to claim 27, wherein a mask of the first set of masks comprises a binary matrix which, when applied to a matrix of the first reference signal, mutes one or more entries of the matrix of the first reference signal.

29. The method according to claim 28, wherein the mask is defined by a combination of at least the following: a comb in time domain, a comb in frequency domain, and a comb in space domain.

30. The method according to claim 27, further comprising:
transmitting, to the one or more user devices, a request for measuring the first masked channel information using the first set of masks.

31. The method according to claim 27, wherein the first masked channel information comprises at least one of the following: reference signal received power, received signal strength indicator, channel frequency response, or channel impulse response measured from the first reference signal applied with the first set of masks.

32. The method according to claim 27, wherein the first sidelink positioning reference signal configuration is determined based at least partly on a mapping of the first masked channel information and one or more sidelink positioning reference signal parameter settings.

33. A non-transitory computer readable medium comprising program instructions which, when executed by an apparatus, cause the apparatus to perform at least the following:
transmitting, to one or more user devices, a message comprising a first reference signal and a first set of masks;
receiving, from the one or more user devices, at least one of the following: first masked channel information per mask of the first set of masks, or a preferred sidelink positioning reference signal configuration based on the first masked channel information; and
determining a first sidelink positioning reference signal configuration based at least partly on the first masked channel information or the preferred sidelink positioning reference signal configuration.

34. The non-transitory computer readable medium according to claim 33, wherein the instructions further causing the apparatus to perform:
determining the first set of masks which, when applied to the first reference signal, emulate a sidelink positioning reference signal with multiple different configurations.

35. The non-transitory computer readable medium according to claim 33, wherein a mask of the first set of masks comprises a binary matrix which, when applied to a matrix of the first reference signal, mutes one or more entries of the matrix of the first reference signal.

36. The non-transitory computer readable medium according to claim 35, wherein the mask is defined by a combination of at least the following: a comb in time domain, a comb in frequency domain, and a comb in space domain.

37. The non-transitory computer readable medium according to claim 33, wherein the instructions further causing the apparatus to perform:
transmitting, to the one or more user devices, a request for measuring the first masked channel information using the first set of masks.

38. The non-transitory computer readable medium according to claim 33, wherein the first masked channel information comprises at least one of the following: reference signal received power, received signal strength indicator, channel frequency response, or channel impulse response measured from the first reference signal applied with the first set of masks.
